(19) United States
(12) Patent Application Publication
(10) Pub. No.: US 2017/0286068 A1
(43) Pub. Date: Oct. 5, 2017

(54) DEVELOPMENT SUPPORT SYSTEM

(71) Applicant: NOMURA RESEARCH INSTITUTE, LTD., Tokyo (JP)

(72) Inventors: Yusuke SHIOKAWA, Tokyo (JP); Eiko MIYAMAE, Tokyo (JP); Mamoru SHIMIZU, Tokyo (JP)

(73) Assignee: NOMURA RESEARCH INSTITUTE, LTD., Tokyo (JP)

(21) Appl. No.: 15/630,322

(22) Filed: Jun. 22, 2017

Related U.S. Application Data
(63) Continuation of application No. PCT/JP2015/051113, filed on Jan. 16, 2015.

(51) Int. Cl. G06F 9/44; G06F 17/24; G06F 3/0484

(52) U.S. Cl. CPC G06F 8/34; G06F 3/04845; G06F 17/248; G06F 8/36; G06F 8/33

(57) ABSTRACT

In a system of developing a screen by reusing a componentized element, the component can be developed while achieving consistency and harmony with an appearance of an entire screen. According to an embodiment, the system has: a component development controller that receives a request for development of a reusable component; a component development model that acquires information containing a source code of the component; and a component development view that displays a predetermined background image on a developer terminal and a component development region for displaying an appearance of the component which is a development target so as to overlap on the background image. When the source code of the component which is the development target is edited, the component which is the development target is displayed based on the source code in the component development region to provide the appearance defined by a template compatible with the device type.

### TECHNICAL FIELD

The present invention relates to a development technique of a Web application, and more specifically, to a technique effectively applied to a development support system that supports development of a Web application performing screen display compatible with multi-devices.

### BACKGROUND ART

In recent years, for example, use of a so-called smart device such as a tablet terminal and a smartphone in business has gained momentum, and the number of system development projects on a medium to large scale linking with a company's core system tends to increase as well. Under such circumstances, requirements of a user company have been more complicated, and the degree of difficulty of development has increased for a developer such as an IT vendor. Therefore, it is important to improve productivity by improving efficiency of the development.

In this respect, it is effective to promote, for example, componentization of a common part/general-purpose part of the development product such as a source code and reuse of a component during the development. Furthermore, it is also effective to reduce an individually-developed part for each device and for each platform by achieving multi-device and multi-platform (hereinafter, simply referred to as “multi-device”) compatibility.

Related to a technique of reusable componentization that is compatible with the multi-device, for example, Japanese Patent Application Laid-open Publication No. 2013-235387 (Patent document 1) describes a Web server system that dynamically changes a user interface including an appearance and an attribute of a control for displaying input/output items, control processing, and others without changing a source code for each device. The system includes, for example, a device acquirement unit that acquires information related to a device type of a client terminal based on a request from the client terminal, and a response processing unit that generates, for apart object contained in the source code, HTML data displaying a corresponding control on a screen of the client terminal on the basis of adjustment contents in displaying the control that is compatible with the device type of the client terminal acquired by the device acquirement unit and that is implemented to an upper class from which the part object is inherited.

### RELATED ART DOCUMENT

### Patent Document

Patent Document 1: Japanese Patent Application Laid-Open Publication No. 2013-235387

### SUMMARY OF THE INVENTION

### Problems to be Solved by the Invention

By using the technique described in, for example, Patent Document 1, in developing a Web application, a component (part object) can be reused, and besides, the multi-device compatibility with one source code can be achieved.

The multi-device compatibility with one source code can be achieved. Nevertheless, it is practically required in some cases to separately writing processing for each device because of, for example, an “if statement” or others in the source code. When a device is newly added, it is required to add processing or others to the source code. Thus, it is difficult for a screen developer to completely achieve the multi-device compatibility with one source code.

Furthermore, even if, for example, the user interface can be changed depending on a screen size of a device as the multi-device compatibility, only a size of a control, a part, and others, a display format thereof, a layout thereof, and others displayed on a certain screen can be changed, and it is difficult to change the user interface with transition of multiple screens.

For example, a screen size of a smartphone is smaller than that of a personal computer (PC) or a tablet terminal, and has limitation on an amount of information that can be displayed thereon. Thus, for example, for display of a list of menus and others, in the PC and the tablet terminal, an interface that displays the list on one screen while all menus are always expanded may be adopted. On the other hand, in the smartphone, an interface may be adopted, the interface displaying only an icon or others for instructing menu display during a normal time but displaying a menu list on a different screen when the menu display is instructed through the icon or others. In the related art, it is difficult to deal with each pattern by one source code in these cases. Accordingly, in the screen development using a reusable component, a system capable of achieving the multi-device compatibility with one source code even when there are different devices is desired.

Meanwhile, in order to achieve the above-described system, it is required to provide the reusable component to the screen developer, and therefore, efficiency is also required for work of creating and developing such a component. The reusable component is ultimately arranged on a screen in combination with a background, another control, another part, and others, and therefore, is required to have consistency and harmony with these elements particularly in terms of appearance. In this respect, when the reusable component is individually developed, trial and error of “creation→execution (display on a test screen)→checking of the appearance→readjustment of the appearance” is repeated, and therefore, work efficiency including preparation of a test environment and others is adversely greatly reduced.

Accordingly, an objective of the present invention is to provide a development support system that enables easy development of a reusable component while achieving consistency and harmony with an appearance of an entire screen in a system that enables screen development of a multi-device compatible Web application by reusing a componentized element.

The above and other object and novel characteristics of the present invention will be apparent from the description of the present specification and the accompanying drawings.

### Means for Solving the Problems

The typical summary of the inventions disclosed in the present application will be briefly described as follows.

A development support system according to a typical embodiment of the present invention is a development support system that supports screen development of a Web application, when receiving a request from a client terminal, which returns a processing result screen compatible with a device type of the client terminal, and this has the following features.

That is, the development support system includes: a template that is formed of a combination of one or more screen parts and that defines an appearance in screen display of each of the screen parts for each type of the device; a component development controller that receives, through a developer terminal, a request for development of a component reusable to the screen development of a Web application; a component development model that acquires information containing a source code of the component based on an instruction from the component development controller; and a component development view that displays, on the developer terminal, a predetermined background image compatible with the device type specified by the developer terminal based on the instruction from the component development controller, and that displays, on the developer terminal, a component development region for displaying an appearance of the component which is a development target so as to overlap on the background image.

Then, when a source code of the component which is the development target is edited, the component which is the development target is displayed based on the source code in the component development region so as to provide the appearance defined by the template compatible with the device type specified by the developer terminal.

### Effects of the Invention

The effects obtained by typical aspects of the present invention will be briefly described below.

That is, according to the typical embodiment of the present invention, in a system that enables screen development of a multi-device compatible Web application by reusing a componentized element, a reusable component can be easily developed while achieving consistency and harmony with an appearance of an entire screen.

### BRIEF DESCRIPTIONS OF THE DRAWINGS

FIG. 1 is a view illustrating an outline of a configuration example of a Web server system according to a first embodiment of the present invention;

FIGS. 2(a) and 2(b) are views each illustrating an outline of an example of a difference in a layout of each device according to the first embodiment of the present invention;

FIGS. 3(a) and 3(b) are views each illustrating an outline of another example of the difference in the layout of each device according to the first embodiment of the present invention;

FIGS. 4(a) and 4(b) are views each illustrating an outline of an example of a difference in a component display of each device according to the first embodiment of the present invention;

FIGS. 5(a) and 5(b) are views each illustrating an outline of another example of the difference in the component display of each device according to the first embodiment of the present invention;

FIG. 6 is a view illustrating an outline of an example of contents specified in an edit view and an accompanying processing flow in screen display according to the first embodiment of the present invention;

FIG. 7 is a view illustrating an outline of a configuration example of a development support system according to a second embodiment of the present invention;

FIG. 8 is a view illustrating an outline of an example of a development screen of a component according to the second embodiment of the present invention;

FIG. 9 is a view illustrating an outline of an example of the development screen of the component according to the second embodiment of the present invention;

FIG. 10 is a view illustrating an outline of an example of the development screen of the component according to the second embodiment of the present invention; and

FIG. 11 is a view illustrating an outline of an example of a processing flow in performing the screen development according to the second embodiment of the present invention.

### BEST MODE FOR CARRYING OUT THE INVENTION

Hereinafter, embodiments of the present invention will be described in detail with reference to the accompanying drawings. Note that the same components are denoted by the same reference symbols in principle throughout all the drawings for describing the embodiments, and the repetitive description thereof will be omitted.

### First Embodiment

<System Configuration>

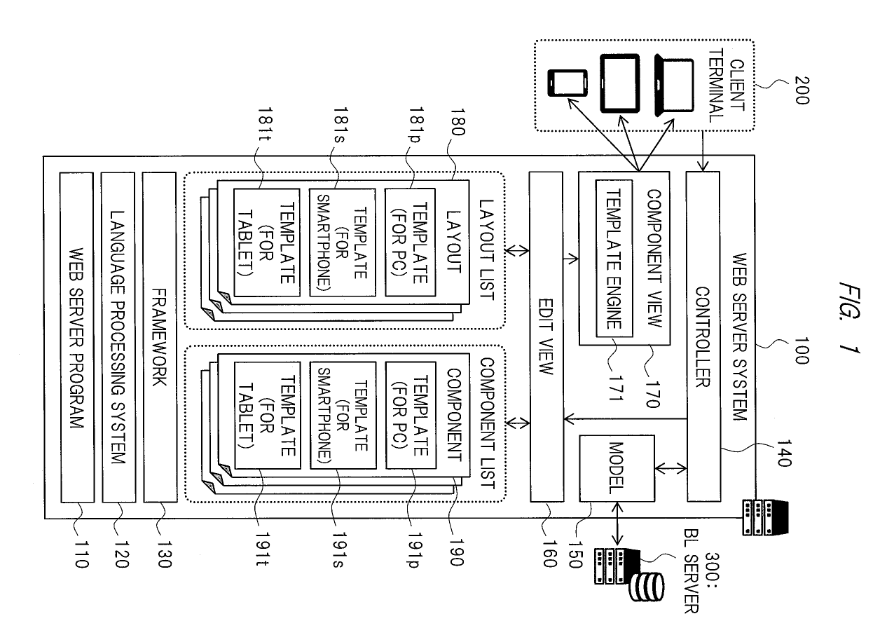

FIG. 1 is a view illustrating an outline of a configuration example of a Web server system according to a first embodiment of the present invention. A Web server system 100 according to the first embodiment of the present invention has a list of components 190 obtained by componentizing screen parts and a list of layouts 180 as layout patterns formed of one or more screen regions where the components 190 are disposed. Each of the layouts 180 and the components 190 has a template that is created so as to output an optimized screen for each device. Based on the template, the Web server system 100 automatically outputs the optimized screen for each device.

The Web server system 100 is, for example, a server system constituted of a server device or a virtual server constructed on a cloud computing service, and has, for example, units (modules) such as a controller 140, a model 150, an edit view 160, a component view 170, the layouts 180, and the components 190, which are developed and implemented by a model view controller (MVC) model and which operate on middleware such as a not-illustrated operating system (OS), a Web server program 110, a language processing system 120, and a framework 130, on a base, or on others.

As the Web server program 110, for example, a server program generally used in a Web server such as an Apache (registered trademark) HTTP server can be used as appropriate. Furthermore, as the language processing system 120 and the framework 130 which are bases of an application system operating on the Web server program 110, for example, a script language such as PHP used for creating a dynamic Web page, Zend Framework implemented in PHP, and others can be used as appropriate.

The controller 140 has a function as a controller (C) in the MVC model, requests the model 150 to perform a data operation to acquire data, and requests the edit view 160 to perform screen display in response to a request from a not-illustrated Web browser or others on a client terminal 200. The model 150 has a function as a model (M) in the MVC model and has a function to perform the data operation and acquisition by executing a business logic. The business logic (BL) may be executed by, for example, making a request to another BL server 300 having a database or others and causing the BL server to execute the business logic.

Each of the edit view 160 and the component view 170 has a function as a view (V) in the MVC model and has a function to perform screen creation based on the data of the model 150 to display the screen. The edit view 160 has a function to construct the screen, and specifies the layouts 180 to be used on the screen, and calls each of the components 190 to be arranged in a region that is displayed by the layouts 180 as described below. Based on information of the layouts 180 and the components 190, the component view 170 performs a rendering operation to create HyperText Markup Language (HTML) data, and outputs the data to the client terminal 200.

At this time, as described below, the component view 170 outputs an optimized screen for a target device by processing a Web template for the screen display that is set for the layouts 180 and the components 190 compatible with a device of the client terminal 200 by using a template engine 171.

As illustrated in the drawing, for each type of the client terminal 200 (a PC, a smartphone, and a tablet terminal), the Web template includes a template (for a PC) 181p, a template (for a smartphone) 181s, and a template (for a tablet) 181t (these may be collectively referred to as a template 181) for the layouts 180, and includes a template (for a PC) 191p, a template (for a smartphone) 191s, and a template (for a tablet) 191t (these may be collectively referred to as a template 191) for the components 190. In the example of FIG. 1, the templates 181 and 191 are prepared separately for the PC, the smartphone, and the tablet terminal. However, the templates 181 and 191 are not limited to them and may also include a template for a different device, a template having a different screen size even for the same type, and a template for a device having a different OS or Web browser.

The template engine 171 has a function to create a practical screen based on contents of a design and an appearance defined by the Web template such as the templates 181 and 191 or others. As the template engine 171, note that, for example, a general template engine such as Smarty mainly used in PHP can be used as appropriate.

The controller 140 and the component view 170 can be provided as a general-purpose Web server system 100. Furthermore, as the layouts 180 and the components 190 (including the templates 181 and 191) serving as the screen components, layouts and components created in another development project can be reused, or layouts and components previously created in a target development project can be used. Furthermore, as for the model 150 as well, models separately created in the target development project or others can be used. On the other hand, the edit view 160 is created as a source code by a screen developer. However, it is not required for the screen developer to take into account the difference of each device since the difference of each device is absorbed by the templates 181 and 191 (and the template engine 171).

<Layout and Component>

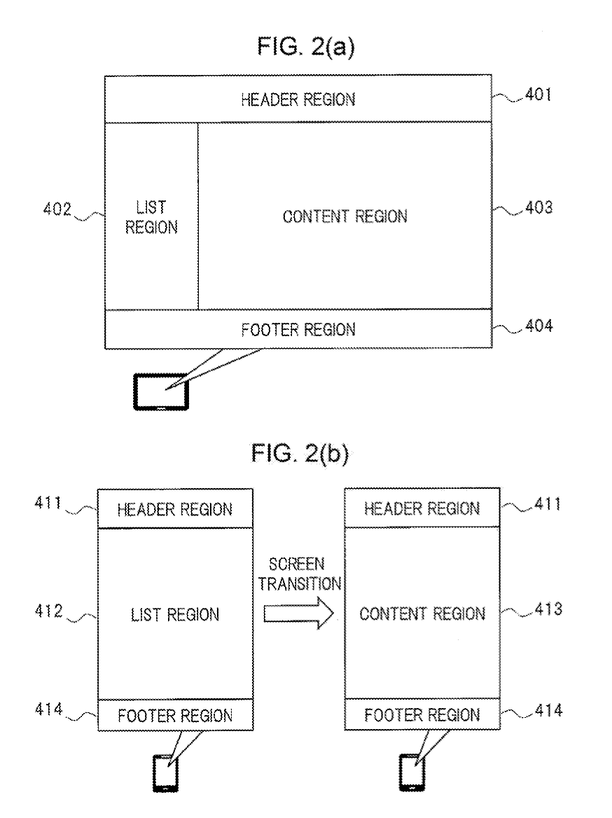

FIGS. 2(a) and 2(b) are views each illustrating an outline of an example of the difference in the layout of each device according to the present embodiment. The layout indicates an arrangement pattern of one or more regions obtained by partitioning an entire screen. FIG. 2(a) illustrates an example of the layout in the tablet terminal, and FIG. 2(b) illustrates an example of the layout in the smartphone.

The examples of FIGS. 2(a) and 2(b) show a case of selecting a “list and detail type layout” as the layouts 180, which illustrates a layout having not only a header region (header regions 401 and 411) and a footer region (footer regions 404 and 414) but also a list region (list regions 402 and 412) where a plurality of items are listed and a content region (content regions 403 and 413) where a detailed content of a specific item that is selected from the list region is displayed.

As illustrated in the drawing, in the layout of FIG. 2(a), all of the four regions are arranged within one screen. On the other hand, the layout of FIG. 2(b) shows a state in which, when the specific item is selected from the list region 412 while the list region 412 is displayed on a left screen, the screen transits to a right screen to display the content region 413 for displaying the selected item in place of the list region 412. Such a difference of each device in the same layout 180 is defined by the template 181 (in this case, the template (for a tablet) 181t and the template (for a smartphone) 181s) as described above, and is reflected on a practical screen by the template engine 171 of the component view 170.

As described above, the difference of each device is absorbed and canceled by the layouts 180 and the templates 181 in terms of not only the component or the control displayed on the screen but also the layout of the entire screen (also including the layout accompanying the screen transition). Accordingly, even in the case with the layout accompanying the screen transition depending on the device, the edit view 160 can be developed without taking into account the device.

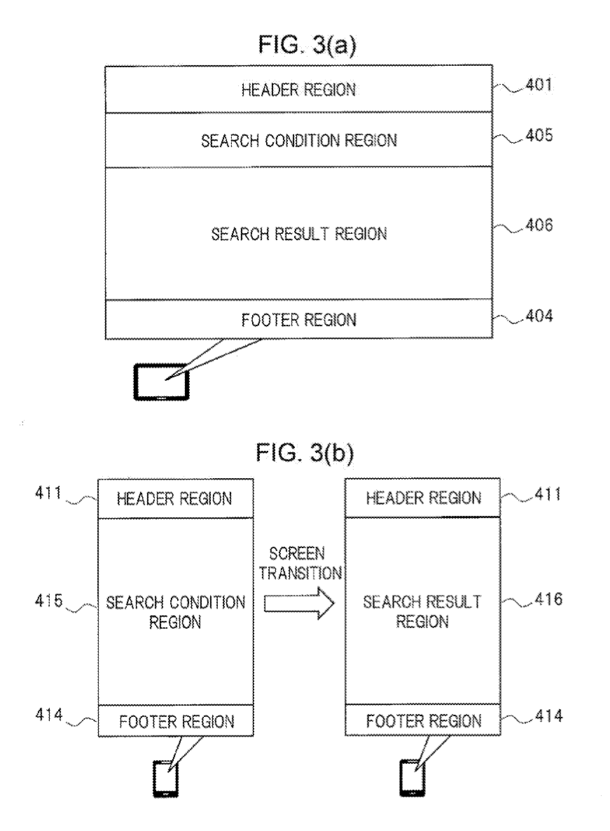

FIGS. 3(a) and 3(b) are views each illustrating an outline of another example of the difference in the layout of each device according to the present embodiment. As similar to FIGS. 2(a) and 2(b), FIG. 3(a) illustrates an example of the layout in the tablet terminal, and FIG. 3(b) illustrates an example of the layout in the smartphone. The example of FIGS. 3(a) and 3(b) illustrates a case of selecting a “search condition and result display type layout” is selected as the layouts 180, and show a layout having not only the header region (header regions 401 and 411) and the footer region (footer regions 404 and 414) but also a search condition region (search condition regions 405 and 415) where a part or others for inputting and specifying a search condition is displayed and a search result region (search result regions 406 and 416) where a search result is displayed based on the search condition.

For example, the layouts 180 specified in the edit view 160 is changed so that arrangement of each of the regions is different between FIG. 3(a) and FIG. 2(a), so that the design and the appearance of each of the regions can be automatically switched by the template engine 171 of the component view 170.

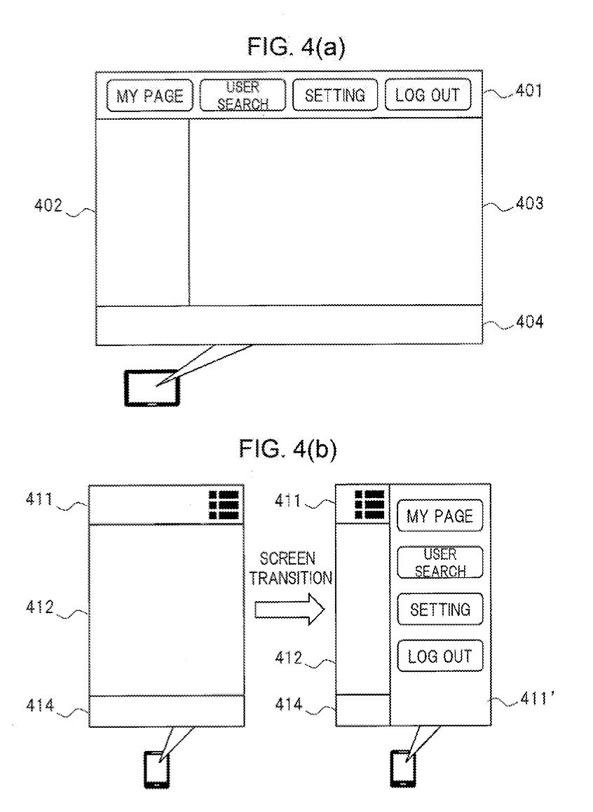

FIGS. 4(a) and 4(b) are views each illustrating an outline of an example of the difference in the component display of each device according to the present embodiment. As similar to FIGS. 2(a) and 2(b), FIG. 4(a) illustrates an example of the layout in the tablet terminal, FIG. 4(b) illustrates an example of the layout in the smartphone, and each of them shows that the components 190 of the “menu” are displayed in the header regions 401 and 411 in the “list and detail type layout” illustrated in the example of FIGS. 2(a) and 2(b).

As illustrated, in the layout in the tablet terminal of FIG. 4(a), four menu buttons are laterally displayed in the header region 401. On the other hand, in the layout in the smartphone of FIG. 4(b), only an icon for displaying the menu is displayed in the header region 411 on the left screen. The drawing shows that the screen transits to the right screen by tapping this icon to expand the header region 411 (becoming a header region 411′) where the menu buttons are longitudinally displayed. Such a difference of each device for the same component 190 is defined by the template 191 (in this case, the template (for a tablet) 191t and the template (for a smartphone) 191s) as similar to the layout 180, and is reflected on the practical screen by the template engine 171 of the component view 170.

Note that the components 190 according to this embodiment are not limited to a component formed of one screen part or one control, and as illustrated, the components may also be formed of a collection or a combination of a plurality of parts and controls (four menu buttons in the example of FIGS. 4(a) and 4(b)).

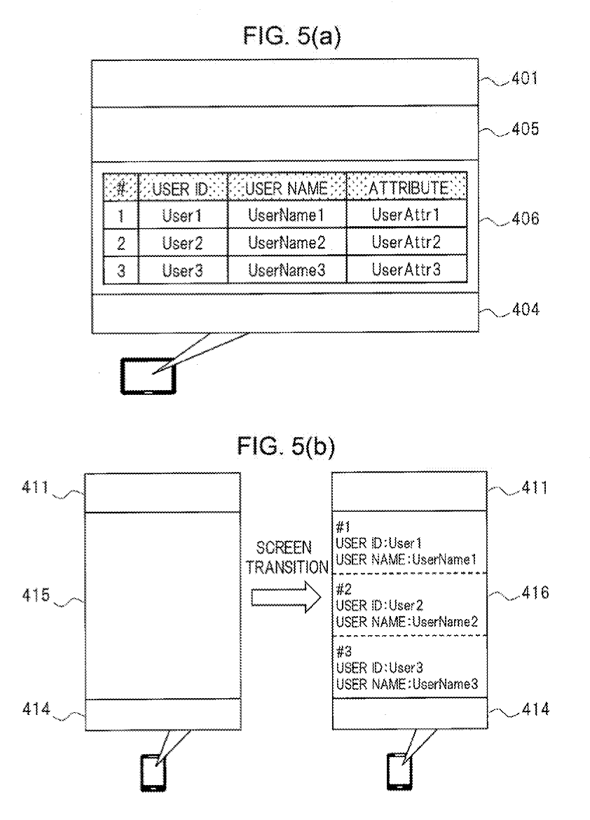

FIGS. 5(a) and 5(b) are views each illustrating an outline of another example of the difference in the component display of each the device according to the present embodiment. As similar to FIGS. 3(a) and 3(b), FIG. 5(a) illustrates an example of the layout in the tablet terminal, FIG. 5(b) illustrates an example of the layout in the smartphone, and each of them shows that the components 190 of a “search result list” is displayed in the search result regions 406 and 416 in the “search condition and result display type layout” illustrated in the example of FIGS. 3(a) and 3(b). As illustrated, in the layout in the tablet terminal of FIG. 5(a), the search result list is displayed in the search result region 406. On the other hand, the layout in the smartphone of FIG. 5(b) shows that the search result list is longitudinally displayed in a list format in the search result region 416 on the right screen to which the screen has transited.

### <Processing Flow>

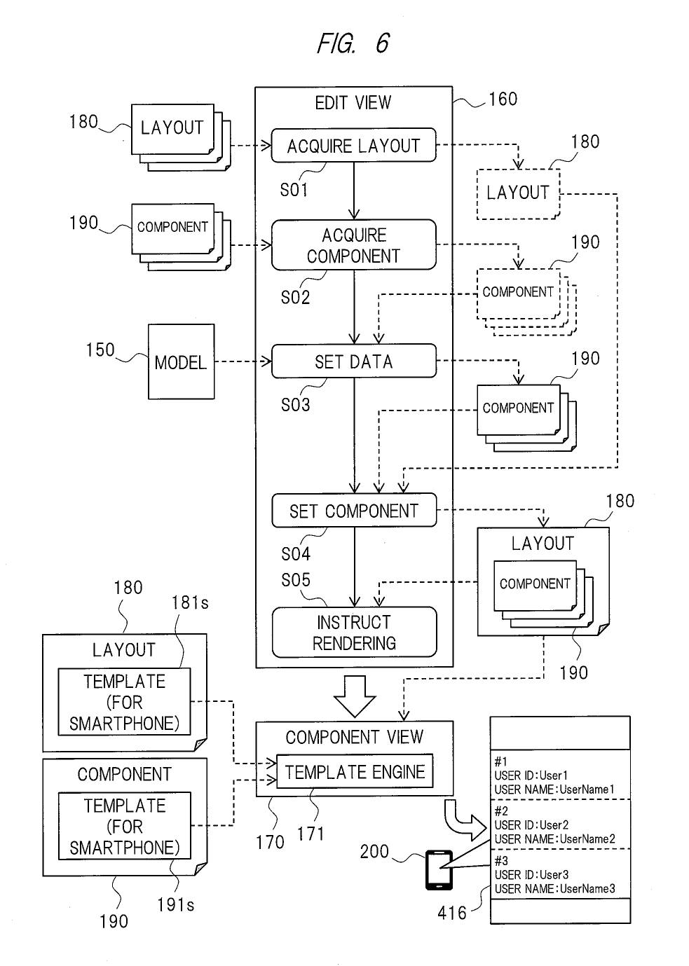

FIG. 6 is a view illustrating an outline of an example of the specified contents in the edit view 160 and an accompanying processing flow in the screen display. As described above, the screen developer creates such an edit view 160 as performing the following processing as the source code. During this, the screen developer only specifies, arranges, and sets the layouts 180 and the components 190 without taking into account the difference of each device. The component view 170 (and the template engine 171) dynamically displays the screen optimized for each device at the time of execution based on the contents defined by the templates 181 and 191.

In the edit view 160, first, the layout 180 used for the screen display is acquired from the previously-created list of the layouts 180 (S01). At this time, any component 190 to be displayed is not arranged yet in each of the regions set in the layouts 180. Next, one or more components 190 to be arranged in the layout 180 which has been acquired in step S01 are acquired from the previously-created list of the components 190 (S02). At this time, any data to be displayed or others is not set yet to the components 190.

Subsequently, the data acquired from the model 150 is set as the data to be displayed to each of the components 190 that have been acquired in step S02 (S03). Note that the acquisition of the data by the model 150 is executed by an instruction through the controller 140. Next, a position of each of the components 190 to which the data has been set is specified so as to be arranged in an appropriate region in the layout 180 acquired in step S01 (S04). Then, the layout 180 that specifies the arrangement position of each of the components 190 is passed to the component view 170, so that the screen rendering is instructed (S05).

At this time, information related to the device type of the client terminal 200 is also passed to the component view 170 (or the component view 170 itself acquires the information from contents of a request message). The information related to the device type can be acquired by a publicly-known technique such as acquisition from a User-Agent header of the request message from the client terminal 200. Note that not only the device type but also, for example, information on an OS, a Web browser, a version thereof, and others, are contained in the information related to the device type described here.

For the layout 180 and each of the components 190 that have been passed to the component view 170, the templates 181 and 191 compatible with the device type are acquired, and the rendering of the screen including the data is performed in accordance with a design defined by the templates. For example, for each of the components 190, the template (for a smartphone) 191s compatible with the device type (a smartphone in the example of FIG. 6) is acquired, and the screen of the component 190 including the data (the list display of the search result in the example of FIG. 6) is rendered based on the design defined by the template. Furthermore, for the layout 180, the template 181s is acquired, and each of the regions is rendered based on the design defined by the template, and besides, each of the screen-rendered components 190 is arranged at a position in the specified region (in the example of FIG. 6, a list display of the search result is arranged in the search result region 416).

As described above, the Web server system 100 according to the first embodiment of the present invention componentizes the screen part, and has a pattern of the layout 180 formed of one or more regions where the component 190 is arranged. Each of the layouts 180 and each of the components 190 respectively have the templates 181 and 191 that are created so as to output the screen optimized for each device. The Web server system 100 includes the component view 170 having the template engine 171 that processes these templates.

Accordingly, the layouts and the components of the screen are componentized, and they are called by the source code of the edit view 160, so that the screen display optimized for each device can be dynamically performed. That is, the screen developer can create the source code of the edit view 160 without taking into account the difference of each device. Furthermore, the development product made by a designer can be easily taken as the screen part by separating a function of controlling the data processing and behavior in the layouts 180 and the components 190 from a design (HTML, cascading style sheets (CSS), and others) defined by the templates 181 and 191.

### Second Embodiment

In the above-described first embodiment, the screen developer can develop the screen by calling the componentized components 190 from the source code of the edit view 160. However, for the development, it is required to previously create and develop the componentized components 190 and to provide the components to the screen developer, and therefore, efficiency is required for the work of the creation and the development of the components 190. The components 190 are ultimately arranged on the screen in accordance with the layout 180 in combination with a background, other components 190, and others, and therefore, are required to be developed while particularly achieving the consistency and the harmony with a surrounding environment in terms of the appearance such as a color and a size.

Accordingly, a development support system according to a second embodiment of the present invention provides a component development function that enables a screen developer to easily develop a usable component 190 while achieving the consistency and the harmony with an appearance of an entire screen. Specifically, the development is achieved by implementing a Web application as one application operating on the Web server system 100 by using the above-described Web server system 100 according to the first embodiment, the Web application being used by the screen developer to develop the usable components 190 while checking the consistency and the harmony with the appearance on a background image that displays the appearance of the entire screen.

<System Configuration>

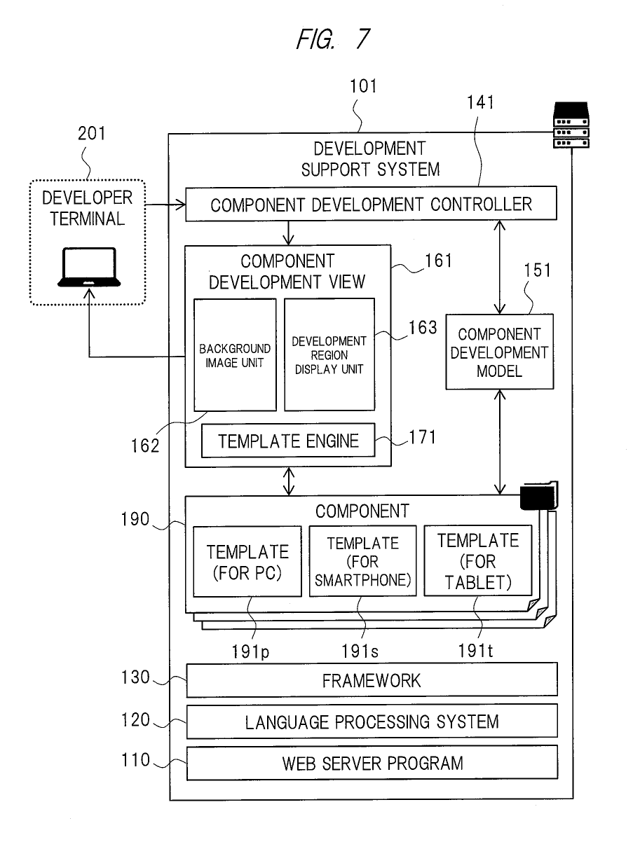

FIG. 7 is a view illustrating an outline of a configuration example of the development support system according to the second embodiment of the present invention. As described above, a development support system 101 according to the present embodiment is a development environment configured based on the Web server system 100 illustrated in FIG. 1 in the first embodiment, and is a system that provides the component development function that enables a developer terminal 201 such as a PC used by the screen developer to develop the reusable components 190 on the background image displaying the appearance of the entire screen.

Since the Web server program 110, the language processing system 120, and the framework 130 in the development support system 101 are the same as those in the Web server system 100 illustrated in FIG. 1 in the first embodiment, descriptions thereof are omitted.

A component development controller 141 has a function as a controller (C) in the MVC model. In the present embodiment, when the component development controller 141 receives a request from a not-illustrated Web browser or others on the developer terminal 201, the component development controller 141 acquires text information of the source code of the components 190, which is developed by the developer using the developer terminal 201, through a component development model 151 described below. It may also have a function of storing and updating the source code. Furthermore, it requests a component development view 161 described below to display, on the screen, a text of the source code or an appearance at the time of execution of the components 190 which are the development targets.

The component development model 151 has a function as a model (M) in the MVC model. In the present embodiment, it acquires information of the components 190 which are the development targets, and responds to the component development controller 141. In order to achieve this in the present embodiment, all of the components 190 (practically, a file recording the source codes of the components 190) are arranged in a predetermined folder or directory.

The component development view 161 has a function as a view (V) in the MVC model and has a function of performing the screen creation based on the data of the component development model 151 and displaying the screen. That is, in the present embodiment, based on the information of the components 190 which are the development targets acquired by the component development model 151, the text of the source code is displayed so as to be editable or the appearance at the time of execution is displayed on the screen together with the background image.

The background image is displayed by a background display unit 162, and the text of the source code of the components 190 and the appearance at the time of execution are displayed by a development region display unit 163. When the appearance at the time of execution of the component 190 is displayed on the screen, the template engine 171 calls and processes the templates that are created so as to output the screen optimized for each device as similar to the first embodiment, so that the display is performed.

The screen display of the components 190 may be switched by using the template and the background image compatible with the specified device by enabling specifying of the device type on the screen displayed on the developer terminal 201. Accordingly, the appearance and others of the components 190 or others can be checked while dynamically switching the screen display for each of the devices on the same developer terminal 201.

In the first embodiment, note that the screen display is optimized by using the layouts 180 compatible with the device of the client terminal 200 on which the screen including the components 190 is displayed. However, in the present embodiment, the components 190 that are still uncompleted during the development are displayed. Therefore, in displaying the appearance of the components 190, the screen using the layouts 180 is not configured, and the appearance is displayed on a fixed background image. Thus, the configuration example of FIG. 7 has a configuration without the list of the layouts 180 in the configuration example illustrated in FIG. 1 according to the first embodiment. On the other hand, the screen display is not limited to this, and the arrangement and the display are performed on the screen by using the layouts 180 in checking the appearance of the components 190 which are the development targets as similar to the first embodiment.

Furthermore, the present embodiment exemplifies the case in which the development support system 101 that is the development environment for the Web application is implemented separately and independently from the Web server system 100 that is an execution environment illustrated in FIG. 1 in the first embodiment. However, these systems can be also configured to coexist as the same server system. Alternatively, this server system can be constructed on the developer terminal 201 to configure a standalone development environment.

### Screen Example

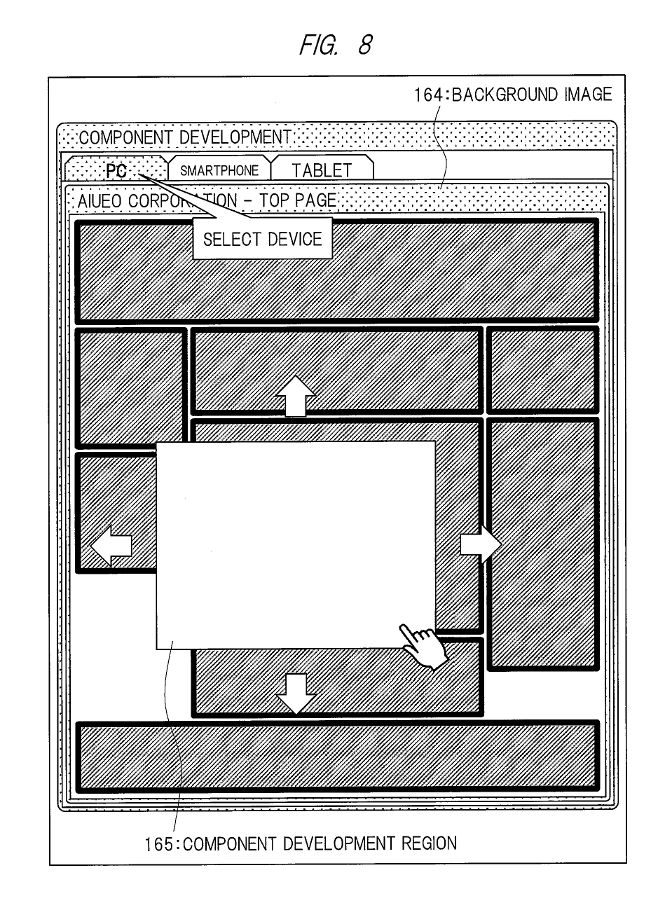

FIGS. 8 to 10 are views each illustrating an outline of an example of the development screen of the components 190 to be displayed on the screen of the developer terminal 201 by the development support system 101. On the development screen, a device which is the development target can be selected in an upper part of the screen (in the example of FIG. 8, a “PC” is selected). The development support system 101 takes a display format compatible with the device that has been selected at this time regardless of a practical device type of the developer terminal 201, so that it emulates the device. In order to achieve this, for example, when a request for displaying the development screen is transmitted from the developer terminal 201 to the development support system 101, an operation or others is performed, the operation updating the information specifying the device contained in the request by the device that has been selected at this time.

The example illustrated in FIG. 8 is an initial screen on which a background image 164 and a white background frame overlapping the background image as a component development region 165 are displayed. In the example of FIG. 8, detailed contents of the background image 164 are omitted. However, each example in terms of the display and the partition of the frame, the control, the part, and others is illustrated with a shaded frame. In the present embodiment, as the background image 164, note that static image data obtained by, for example, screen capture of a top page of a Web site which is a development target or others is used. However, the background image is not limited to this. For example, a screen can be also used, the screen being obtained by dynamically rendering the respective components 190 arranged based on the layout 180 using the same configuration as that described in the first embodiment to be compatible with the device type.

The developer can change a size of the component development region 165 by using a mouse or others, and move the component development region to an appropriate position by a drag and drop operation. The size set here may automatically be set in the source code so that the components 190 that have been developed are in sizes to be practically displayed. As for the position, when the components 190 are practically used, note that the arrangement positions are defined by the layout 180 as described in the first embodiment.

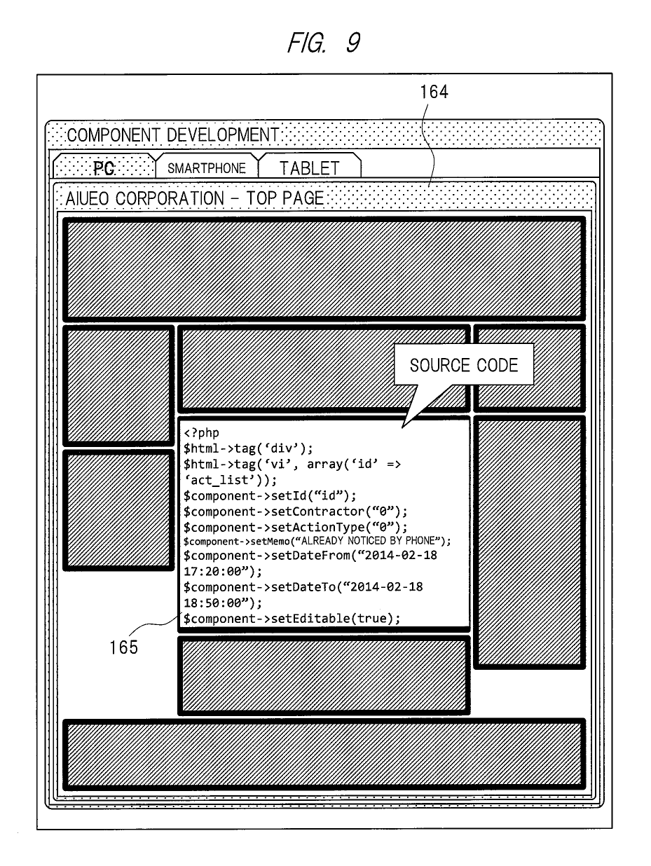

The component development region 165 is configured so that text editing is possible in a development mode in an initial state. After setting the size and the position of the component development region 165, the developer directly edits the source code within the component development region 165 as illustrated in the example of FIG. 9. The edited source code can be directly saved as, for example, the source code of the component 190 on a server side, that is, on the development support system 101 by an instruction and an operation of the developer through a not-illustrated save button or others.

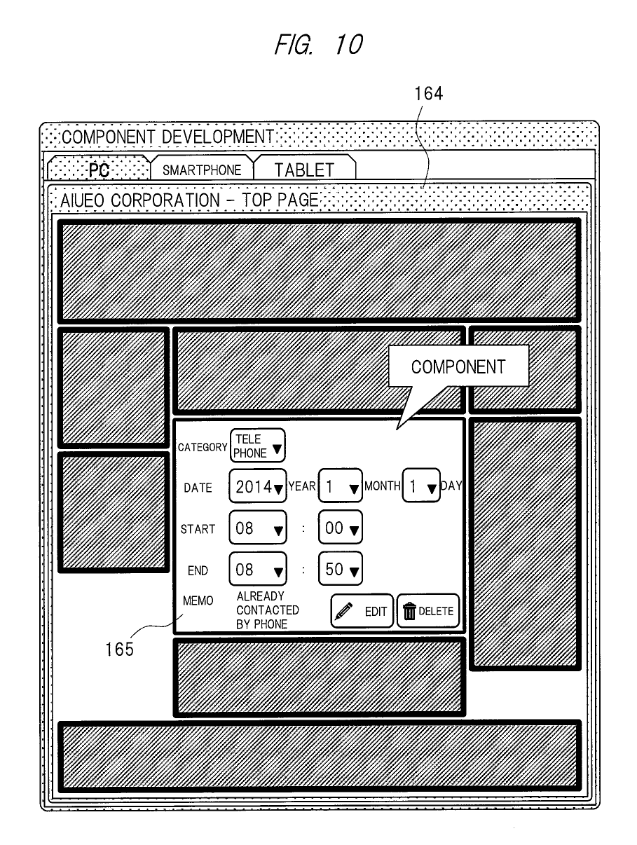

In order to check the appearance of the components 190 based on the developed source code or others, the component development region 165 is switched from the development mode to a checking mode based on an instruction and an operation of the developer. In the checking mode, the component development region 165 can call the target components 190 to practically display the appearance at the time of execution on the screen through the template engine 171 as illustrated in the example of FIG. 10. After checking the operation and the appearance of the components 190 for the consistency and the harmony with the background image 164 or others, the developer can return the mode to the development mode illustrated on the screen of FIG. 9, and correct the source code or others again.

As a development function such as the edition and the saving of the source code and version management, note that a generally-available external development environment such as Eclipse can be used. In this case, the developer may directly edit and save the source code or others on the Eclipse, or may edit the component development region 165 in this region as an external editor or others.

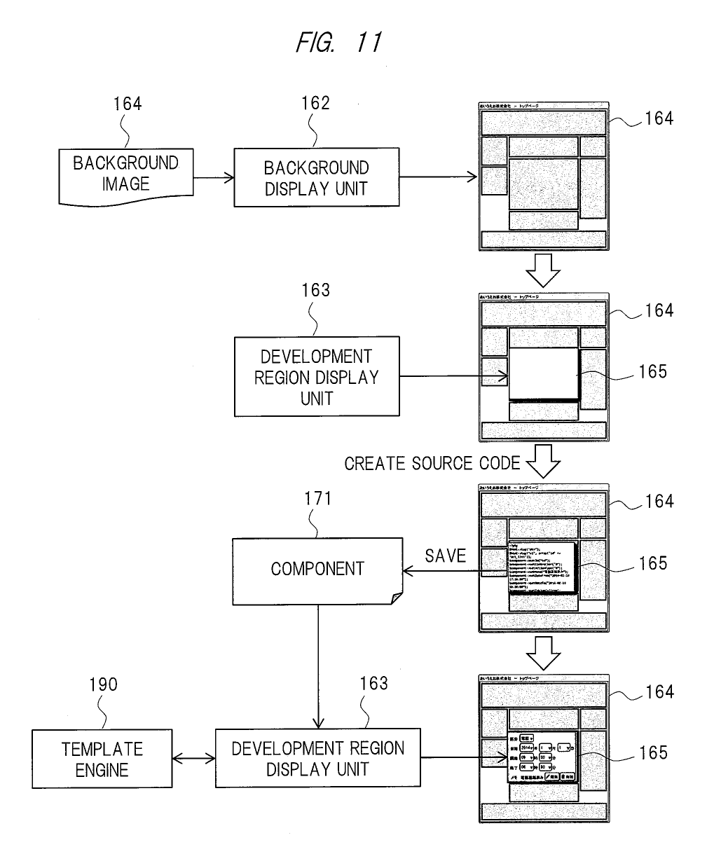

FIG. 11 is a view illustrating an outline of an example of a processing flow in a case of the screen development on the developer terminal 201 by the development support system 101. Here, the drawing illustrates an outline of the processing flow illustrated in the screen examples of FIGS. 8 to 10, and the background display unit 162 in the component development view 161 of the development support system 101 displays the background image 164 first on the not-illustrated Web browser of the developer terminal 201. The data of the background image 164 may be, for example, previously registered in the development support system 101 or specified by the developer at any time. Furthermore, the development region display unit 163 in the component development view 161 displays the component development region 165 having a white background to overlap the background image to enter the development mode.

Note that the component development region 165 can be formed as, for example, a nesting browser element relative to the not-illustrated Web browser that displays the development screen on the developer terminal 201 by usage of an inline frame with an IFRAME tag. Furthermore, in the example described above, the component development region 165 having a white background is displayed by the new development of the components 190. However, an existing component 190 may be called for a correction purpose by an instruction from the developer so as to display the source code.

The developer sets the size and the position of the component development region 165 as illustrated in FIG. 8, and then, creates and saves the source code as illustrated in FIG. 9. The source code of the component 190 is saved in a predetermined folder or directory on the development support system 101. Then, when the mode is switched from the development mode to the checking mode by the instruction of the developer or others, the component development view 161 calls the target components 190, forms the appearance by the template engine 171, and displays them on the component development region 165 as illustrated in FIG. 10.

When the external development environment such as Eclipse is used as the development environment of the source code, for example, the component development region 165 is always in the checking mode, and the updating, the saving and others for the source code executed on the Eclipse is monitored by the development region display unit 163 of the component development view 161, so that the updated target components 190 can be called, and the appearance thereof can be dynamically displayed in the component development region 165.

As described above, in the development support system 101 according to the second embodiment of the present invention, the developer to switch can switch the development of the source code of the components 190 and the display of the appearance thereof at the time of execution at any time on the component development region 165, which is overlapped and displayed on the background image 164 on the developer terminal 201. Accordingly, the components 190 can be effectively developed while checking the consistency and the harmony of the appearance on the entire screen as appropriate.

In the foregoing, the invention made by the present inventors has been concretely described based on the embodiments. However, it is needless to say that the present invention is not limited to the foregoing embodiments and various modifications and alterations can be made within the scope of the present invention. For example, the above-described embodiments have been explained for easily understanding the present invention, but are not always limited to the one including all structures explained above. Also, a part of the structure of one embodiment can be replaced with the structure of the other embodiment, and besides, the structure of the other embodiment can be added to the structure of one embodiment. Further, the other structure can be added to/eliminated from/replaced with a part of the structure of each embodiment.

### INDUSTRIAL APPLICABILITY

The present invention can be used for the development support system that supports development of a Web application performing multi-device compatible screen display.

### EXPLANATION OF REFERENCE CHARACTERS

100 . . . Web server system, 101 . . . development support system, 110 . . . Web server program, 120 . . . language processing system, 130 . . . framework, 140 . . . controller, 141 . . . component development controller, 150 . . . model, 151 . . . component development model, 160 . . . edit view, 161 . . . component development view, 162 . . . background display unit, 163 . . . development region display unit, 164 . . . background image, 165 . . . component development region, 170 . . . component view, 171 . . . template engine, 180 . . . layout, 181p . . . template (for a PC), 181s . . . template (for a smartphone), 181t . . . template (for a tablet), 190 . . . component, 191p . . . template (for a PC), 191s . . . template (for a smartphone), 191t . . . template (for a tablet), 200 . . . client terminal, 201 . . . developer terminal, 300 . . . BL server, 401 . . . header region, 402 . . . list region, 403 . . . content region, 404 . . . footer region, 405 . . . search condition region, 406 . . . search result region, 411 and 411′ . . . header region, 412 . . . list region, 413 . . . content region, 414 . . . footer region, 415 . . . search condition region, and 416 . . . search result region

1. A development support system that supports screen development of a Web application that receives a request from a client terminal and that returns a processing result screen compatible with a device type of the client terminal, the development support system comprising:
a template that is formed of a combination of one or more screen parts and that defines an appearance of each of the screen parts when being displayed on a screen for each of the device types;
a component development controller that receives, through a developer terminal, a request for development of a component reusable to the screen development of the Web application;
a component development model that acquires information containing a source code of the component based on an instruction from the component development controller; and
a component development view that displays, on the developer terminal, a predetermined background image compatible with the device type specified by the developer terminal based on the instruction from the component development controller, and that displays, on the developer terminal, a component development region for displaying the appearance of the component which is a development target so as to overlap on the background image,
wherein, when the source code of the component which is the development target is edited, the component which is the development target is displayed based on the source code in the component development region so as to provide the appearance defined by the template compatible with the device type specified by the developer terminal.

2. The development support system according to claim 1,
wherein a size and/or a position of the component development region can be changed by an instruction of a developer.
